(19) United States
(12) Patent Application Publication
(10) Pub. No.: US 2016/0275811 A1
(43) Pub. Date: Sep. 22, 2016

(54) Three-dimensional Triangular Paper Block Folding Aid

(71) Applicant: Lisa Li-Hsiang Lin, Taipei (TW)

(72) Inventor: Lisa Li-Hsiang Lin, Taipei (TW)

(21) Appl. No.: 15/065,933

(22) Filed: Mar. 10, 2016

(30) Foreign Application Priority Data
Mar. 16, 2015 (TW) 104203855

(51) Int. Cl. G09B 19/00

(52) U.S. Cl. CPC G09B 19/00

(57) ABSTRACT

A three-dimensional triangular paper block paper folding aid includes a primary forming board, which the top end being a base block, and the base block extends obliquely towards both sides to form two isosceles upper bevels, and then extends inwardly and obliquely to form two isosceles lower bevels, which being coupled into a right angle (90°). One of the sides of the primary forming board has a vertical midline with a length substantially equal to half of the length of the folding paper, and the turning points between the two upper bevel edges and two lower bevel edges on the other side of the primary forming board are connected into a horizontal midline with a width substantially equal to the width of the folding paper, and the vertical midline and the horizontal midline provide a positioning guide to the folding paper.

### BACKGROUND OF THE INVENTION

1. Field of the Invention

The present invention relates to a paper folding aid, and more particularly to a three-dimensional triangular paper block folding aid capable of guiding the folding sequence of the folding paper and setting the specification of the folding paper while conducting the handcraft of folding paper to produce the three-dimensional triangular paper block, so as to accelerate the production of the three-dimensional triangular paper blocks with the same size and specification precisely.

2. Description of the Related Art

Origami (folding paper) is a handcraft which may be divided into at least the following two operating modes. 1. A piece of paper is folded into a shape of an animal, a flower, or an imitated object according to a certain folding sequence. 2. A piece of paper is folded into a semi-finished product which is called a “three-dimensional triangular paper block” according to a certain folding sequence, and then several three-dimensional triangular paper blocks are arranged next to one another, and then a part or the whole of the three-dimensional triangular paper blocks are connected and combined to form a planar or three-dimensional model. For example, a planar fish or puzzle, a three-dimensional bird or coconut tree, or any other vivid model may be formed, and the model may be colored or affixed with accessories to improve the fidelity and add more fun to the product.

The art of forming the three-dimensional triangular paper blocks by folding and then connecting the three-dimensional triangular paper blocks to produce a specific model is a conventional handcraft. Up to now, the handcraft cannot be replaced by machines and totally relies on a manual procedure to fold pieces of paper into the three-dimensional triangular paper blocks and then design and produce a model by connecting and combining the three-dimensional triangular paper blocks. It is no double that such art is a conventional handcraft.

Although the handcraft of applying the combination of the three-dimensional triangular paper blocks to produce a specific model is a well known art, yet the process of folding the pieces of paper one by one into the three-dimensional triangular paper blocks must be done manually, and such manufacturing process is complicated, slow and boring, and the precision and consistency of the specification cannot be controlled easily. As a result, the performance of connecting and combining the three-dimensional triangular paper blocks may be affected. Sometimes, the three-dimensional triangular paper blocks have to be connected or combined by glues, and the original fun of combining blocks freely is lost, and the origami lovers are deterred, and the art cannot be spread widely since the origami lovers. Although origami is promoted through the Internet, the art is still a private hobby for a small population and it is regretful that origami cannot be flourished.

### SUMMARY OF THE INVENTION

In view of the aforementioned drawbacks, the inventor of the present invention based on the deep love of the conventional origami handcraft of producing the three-dimensional triangular paper block to conduct researches and experiments, and finally designed and developed the three-dimensional triangular paper block folding paper in accordance with the present invention.

It is a primary objective of the present invention to provide a three-dimensional triangular paper block folding paper aid capable of guiding the sequence of the origami handcraft and specifying the specification of the origami to achieve the effect of folding the three-dimensional triangular paper blocks with the same size and specification precisely and quickly.

To achieve the aforementioned and other objectives, the present invention provides a three-dimensional triangular paper block paper folding aid with a specification matched with the specification of a folding paper, comprising a primary forming board, and the top end of the primary forming board being a base block capable of providing a positioning guide to the folding paper, and an edge of the primary forming board being extended obliquely from the base block towards both sides to form two isosceles upper bevel edges, and then extended inwardly and obliquely to form two isosceles lower bevel edges, and the two isosceles lower bevel edges being coupled into a right angle) (90°. One of the sides of the primary forming board has a vertical midline at a vertical centerline position, and the length of the vertical midline is substantially equal to half of the length of the matched folding paper to provide a vertical positioning guide to the folding paper. The other side of the primary forming board has a horizontal line formed by connecting the turning points between the two upper bevel edges and the two lower bevel edges, and the width of the horizontal midline is substantially equal to the width of the matched folding paper to provide a horizontal positioning guide to the folding paper. Both vertical and horizontal midlines have the function of providing a positioning guide to the folding paper.

In the three-dimensional triangular paper block paper folding aid, the primary forming board is coupled to a forming board for assisting other folding paper functions to conduct other necessary folding paper procedures or coupled to an outer frame, so that the primary forming board is suspended by a stand/or a connecting rod in order to connect more forming boards with other folding paper functions and conduct more other necessary folding paper procedures.

In the three-dimensional triangular paper block paper folding aid, the top of the primary forming board is coupled to a first forming board which is formed by a rectangular thin plate with a width substantially equal to the length of the matched folding paper and a height substantially equal to half of the width of the matched folding paper, and the back side of the primary forming board is provided for positioning and installing the folding paper.

In the three-dimensional triangular paper block paper folding aid having the outer frame, and the middle position of the outer frame is downwardly coupled to the primary forming board by a connecting rod.

In the three-dimensional triangular paper block paper folding aid having the outer frame, a stand is extended inwardly from both sides of the outer frame, and the primary forming board is suspended downwardly from a middle position of the stand.

In the three-dimensional triangular paper block paper folding aid having the outer frame, each outer frame disposed on the outer side of the two lower bevel edges of the primary forming board has a positioning device for precisely aligning the connecting points of the bottom edge and the two lower bevel edges.

In the three-dimensional triangular paper block paper folding aid having the outer frame, and a first forming board is coupled to the outer frame at a position proximate to the top end and between both sides of the outer frame, and the first forming plate is formed by a rectangular thin plate with a width substantially equal to the length of the matched folding paper and a height substantially equal to half of the width of the matched folding paper, and the back side of the outer frame has a positioning device for positioning the folding paper.

In the three-dimensional triangular paper block paper folding aid having the outer frame, an inner bottom of the outer frame is coupled to a second forming board which is formed by an inverted triangular thin plate with a specification substantially the same as the specification of the lower half of the primary forming board, and the back side of the outer frame is provided for positioning and installing the folding paper.

In the three-dimensional triangular paper block paper folding aid, the upper bevel edge and lower bevel edge of the primary forming board are preferably in the shape of a sharp wall.

In the three-dimensional triangular paper block paper folding aid, the top edge of the first forming board is preferably in the shape of a sharp wall.

In the three-dimensional triangular paper block paper folding aid, the top edge of the second forming board is preferably in the shape of a sharp wall.

In the three-dimensional triangular paper block paper folding aid, the three-dimensional triangular paper block paper folding aid is operated freely without being limited by forward, backward, up, down, left, and right directions.

### BRIEF DESCRIPTION OF THE DRAWINGS

FIG. 1 is a perspective front view of a first embodiment of the present invention;

FIG. 2 is a perspective rear view of the first embodiment of the present invention;

FIG. 3 is a front view of the first embodiment of the present invention;

FIG. 4 is a rear view of the first embodiment of the present invention;

FIG. 5 is a first schematic front view of using a first forming plate to guide a folding paper to be folded in accordance with the first embodiment of the present invention;

FIG. 6 is a second schematic front view of using a first forming plate to guide a folding paper to be folded in accordance with the first embodiment of the present invention;

FIG. 7 is a schematic view of completing the procedure of folding a folding paper and turning over the folding paper by a first forming board in accordance with the first embodiment of the present invention;

FIG. 8 is a first schematic front view of using a primary forming board to guide a folding paper to be folded in accordance with the first embodiment of the present invention;

FIG. 9 is a second schematic front view of using a primary forming board to guide a folding paper to be folded in accordance with the first embodiment of the present invention;

FIG. 10 is a third schematic front view of using a primary forming board to guide a folding paper to be folded in accordance with the first embodiment of the present invention;

FIGS. 11a˜b are front and rear views of completing the procedure of folding a folding paper by a primary forming board in accordance with the first embodiment of the present invention;

FIG. 12 is a first front view showing the procedure of guiding a folding paper to be folded by a second forming board in accordance with the first embodiment of the present invention;

FIG. 13 is a second front view showing the procedure of guiding a folding paper to be folded by a second forming board in accordance with the first embodiment of the present invention;

FIG. 14 is a third front view showing the procedure of guiding a folding paper to be folded by a second forming board in accordance with the first embodiment of the present invention;

FIG. 15 is a fourth front view showing the procedure of guiding a folding paper to be folded by a second forming board in accordance with the first embodiment of the present invention;

FIG. 16 is a perspective view of a three-dimensional triangular paper block manufactured in accordance with an embodiment of the present invention;

FIG. 17 is a perspective view of connecting and combining the adjacent front and rear three-dimensional triangular paper blocks of the present invention;

FIG. 18 is a front view of a changed structure of the first embodiment of the present invention;

FIG. 19 is a rear view of a changed structure of the first embodiment of the present invention;

FIG. 20 is a perspective front view of a second embodiment of the present invention;

FIG. 21 is a perspective rear view of the second embodiment of the present invention;

FIG. 22 is a front view of the second embodiment of the present invention;

FIG. 23 is a rear view of the second embodiment of the present invention;

FIG. 24 is a first rear view showing the procedure of guiding a folding paper to be folded by a primary forming board in accordance with the second embodiment of the present invention;

FIG. 25 is a second rear view showing the procedure of guiding a folding paper to be folded by a primary forming board in accordance with the second embodiment of the present invention;

FIG. 26 is a third rear view showing the procedure of guiding a folding paper to be folded by a primary forming board in accordance with the second embodiment of the present invention;

FIG. 27 is a perspective front view of a third embodiment of the present invention;

FIG. 28 is a perspective rear view of the third embodiment of the present invention;

FIG. 29 is a front view of the third embodiment of the present invention;

FIG. 30 is a rear view of the third embodiment of the present invention;

FIGS. 31 (a)˜(e) are schematic front views showing the procedure of guiding a folding paper to be folded in accordance with the third embodiment of the present invention;

FIG. 32 is a front view of a changed structure of the third embodiment of the present invention; and

FIG. 33 is a rear view of a changed structure of the third embodiment of the present invention.

### DETAILED DESCRIPTION OF THE PREFERRED EMBODIMENTS

The technical characteristics, contents, advantages and effects of the present invention will be apparent with the detailed description of a preferred embodiment accompanied with related drawings as follows.

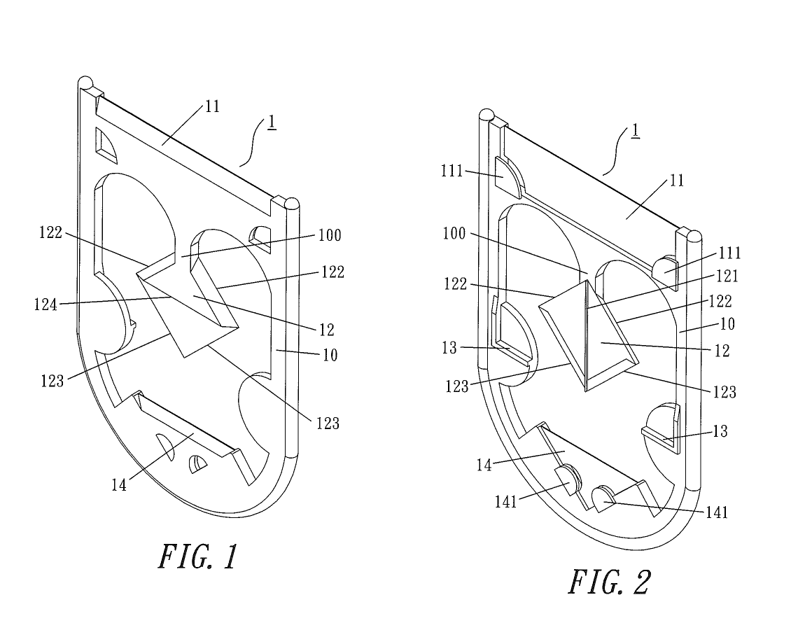

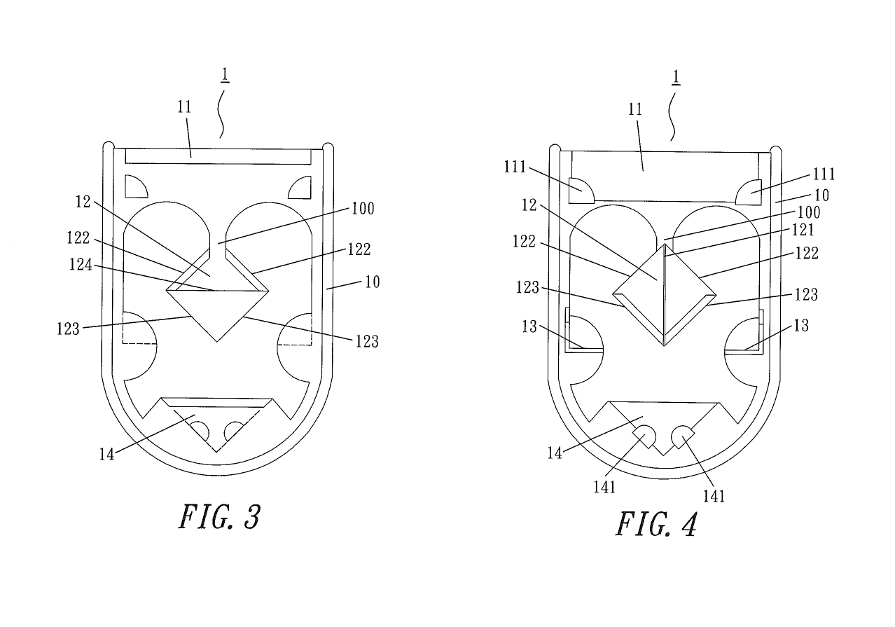

The sequence of the whole procedure of folding a folding paper by a paper folding aid will be described as follows. With reference to FIGS. 1 to 4 for a three-dimensional triangular paper block folding aid 1 in accordance with the first embodiment of the present invention, the paper folding aid 1 has a substantially U-shaped outer frame 10, and a first forming board 11 formed by a rectangular thin plate at a position proximate to the top end and between both sides of the outer frame 10, and the first forming board 11 has a width substantially equal to the length of the folding paper and a height substantially equal to half of the width of the folding paper, and the top edge is in the shape of a sharp wall, and the bottom edge and each of the two back sides of the outer frame 10 is coupled to a press plate 111, so that a positioning and disposing position with a small space between each press plate 111 and the first forming board 11 is formed, and the first forming board 11 has a stand 100 is extended downwardly from both sides of the outer frame 10, and a primary forming board 12 is suspended downwardly and directly from a middle position of the stand 100. In other words, the connection position of the stand 100 and the primary forming board 12 is just like a base block, so that the primary forming board 12 is situated at a status of being suspended in an internal space of the outer frame 10. The figures clearly show that an open space is formed between the outer frame 10 on both sides and the stand 100 at the middle and provided for accommodating a user's fingers to facilitate the folding paper operation. The primary forming board 12 has a vertical midline 121 disposed at a centerline position of one of the sides vertical and a length substantially equal to half of the length of the folding paper to provide a vertical positioning guide to the folding paper P. An edge of the primary forming board 12 is extended obliquely from the base block (which is at the connecting position of the stand 100 and the primary forming board 12) towards both sides to form two isosceles upper bevel edges 122, and then extended obliquely inward to form two isosceles lower bevel edges 123, and the two lower bevel edges 123 are extended and connected into a right angle (90°), and the turning points between the two upper bevel edges 122 and the two lower bevel edges 123 are connected to form a horizontal midline 124 with a width substantially equal to the width of the folding paper P, and the height difference between the upper half and the lower half of the structure provides a horizontal positioning guide to the folding paper P, and the upper bevel edges 122 and lower bevel edges 123 are preferably edges in the shape of a sharp wall. Each of both sides of the outer frame 10 disposed on the outer sides of the two lower bevel edges 123 has a right angled placement stair 13 having the connecting points of the bottom edge and the two lower bevel edges 123 aligned precisely with one another, so that the folding paper P also has the function of a horizontal positioning guide. A second forming board 14 made of an inverted triangular thin plate is formed at an inner bottom of the outer frame 10 and has a size substantially the same as the specification of an inverted triangle formed by the two lower bevel edges 123 of the primary forming board 12, and a top edge preferably in the shape of a sharp wall, and the back side of each of the two bevel edges of the second forming board 14 is coupled to a press plate 141 by the outer frame 10, so that a positioning and disposing position having a small space between each press plate 141 and the second forming board 14 is formed. The figures clearly shows that an open space is formed between the second forming board 14 and the primary forming board 12 and provided for accommodating a user's fingers to facilitate the folding paper operation.

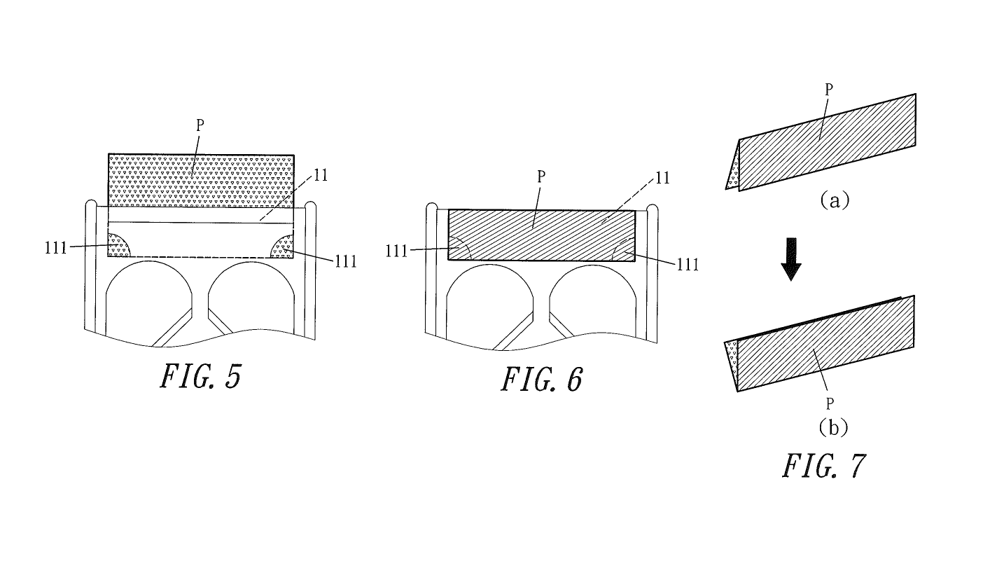

During use, the first forming board 11, the primary forming board 12 and the second forming board 14 are used sequentially to assist the necessary movements of folding a folding paper P, and the specification of the folding paper P includes a length substantially equal to the width of the first forming board 11 and a width substantially equal to twice of the height of the first forming board 11. The way of using the paper folding aid 1 to assist the operation of folding the folding paper P according to a specification precisely is described below. Firstly, the lower half below the centerline of the folding paper P inserted into the accommodating space formed between the press plate 111 and the first forming board 11, so that the back side of the folding paper P is attached to the back side of the first forming board 11 as shown in FIG. 5, and then upper half of the folding paper P is bent downwardly by the top edge of the first forming board 11 to attach to the front side of the first forming board 11 as shown in FIG. 6. Now, the step of using the first forming board 11 to fold the folding paper is completed, and then the folded folding paper P is removed from the first forming board 11 as shown in FIG. 7 (a) before turning the folding paper P upside down, so that the folded opening edge faces upward as shown in FIG. 7(b).

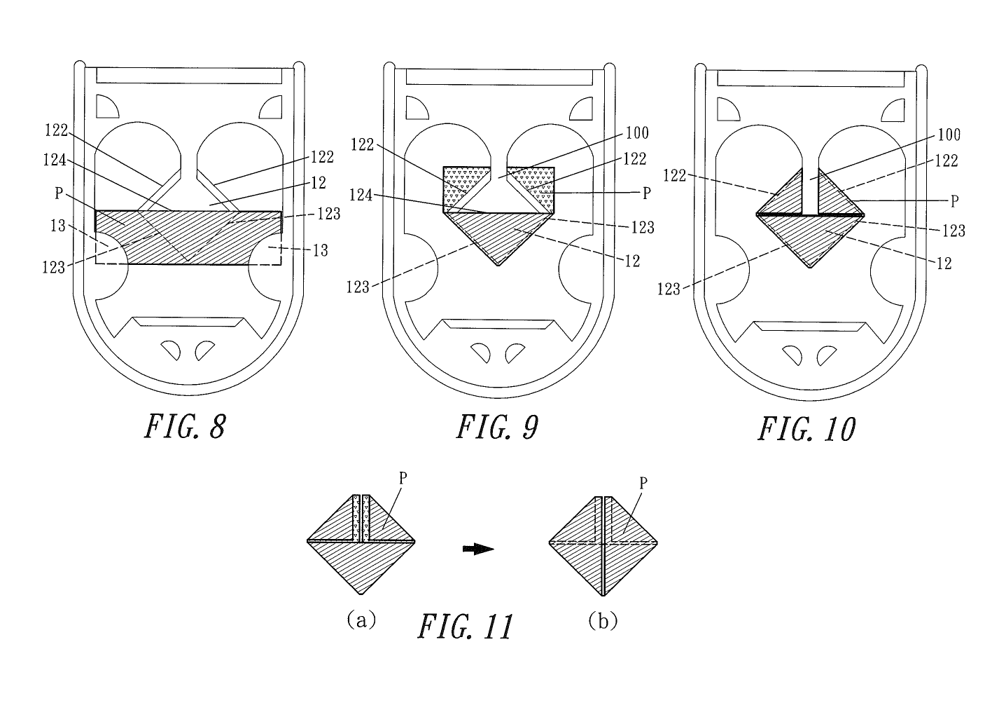

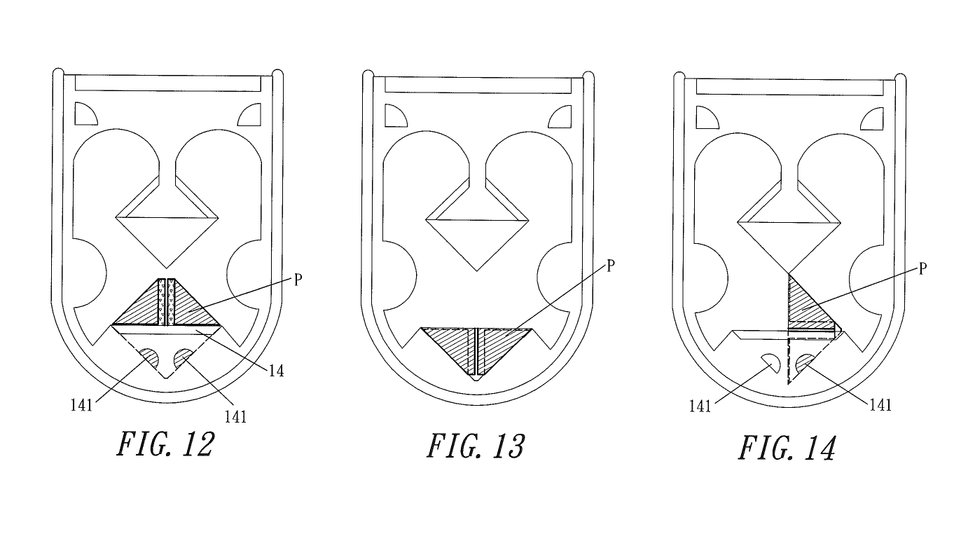

And then, the two right-angled (90°) corners of the lower half of the folded folding paper P with an opening edge facing upward are placed on a placement stair 13 on both sides of the outer frame 10, while placing the paper surface flatly to the front of the primary forming board 12 as shown in FIG. 8. Since the specification of the primary forming board matches the size of the folding paper P, therefore the upper edge of the folded folding paper P will be aligned precisely with the horizontal midline 124. And then, both left and right end surfaces of the folded folding paper P are obliquely and upwardly folded along the two lower bevel edges 123 and bent into 45° as shown in FIG. 9. Now, the obliquely and upwardly folded end surfaces are engaged closely along the vertical midline 121 at the middle of the back side of the primary forming board 12, and the top edges of the end surfaces will be aligned precisely with the lower end of the base block (which is the connecting position of the stand 100 and the primary forming board 12). And then, the two upwardly and obliquely folded end surfaces of the two upper bevel edges 122 are folded downwardly and obliquely from the back to the front as shown in FIG. 10. Now, the step of using the primary forming board 12 to fold the folding paper P covered onto the primary forming board 12 is completed. And then, the covered folding paper P is removed from the primary forming board 12 by releasing the previous folding paper step. With reference to FIGS. 11 (a) and (b) for the front and rear views of the independent folding paper P respectively, the appearance of the folding paper P is substantially the same as the shape of the primary forming board 12, and its upper half is divided into a form with left and right wings, and one of the sides of the lower half is in the shape of an isosceles right-angled triangle, and the other side is in the shape of the divided two small right-angled triangles.

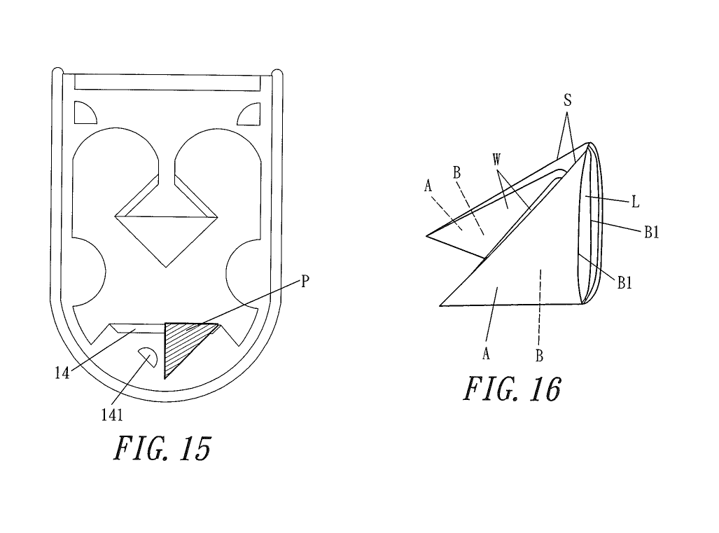

Now, the lower half of the folding paper P as shown in FIG. 11 (a) is inserted downwardly into the accommodating space of the second forming board 14 formed between each press plate 141 and the second forming board 14, so that one side of the isosceles right-angled triangle is attached to the second forming board 14 as shown in FIG. 12, and then the left and right wing shaped upper half is folded forwardly and downwardly by the top edge of the second forming board 14 and attached to the front side of the second forming board 14 as shown in FIG. 13. Now, the folding paper P is folded into the shape of an isosceles right-angled triangle with one side attached to the two separated wings, and the other side is in the formed of the divided two small right-angled triangles. And then, the folding paper P in the current status is removed upwardly from the second forming board 14 and rotated 90° to the left side (or the right side), and the sharp corner facing downward in this status is inserted into an accommodating space formed between the press plate 141 on the right side (or the left side) of the second forming board 14 and the second forming board 14, so that the two divided wing shaped surfaces face towards the second forming board 14 as shown in FIG. 14, and then half of the isosceles right-angled triangle protruded from the top of the second forming board 14 is folded downwardly by top edge of the second forming board 14 and attached to the front side of the second forming board 14 as shown in FIG. 15. Now, the step of folding the paper by the second forming board 14 is completed. And then, the folded folding paper P is removed from the second forming board 14, and now the independent folding paper P is folded into the three-dimensional triangular paper block as shown in FIG. 16. The whole process of folding a three-dimensional triangular paper block is completed.

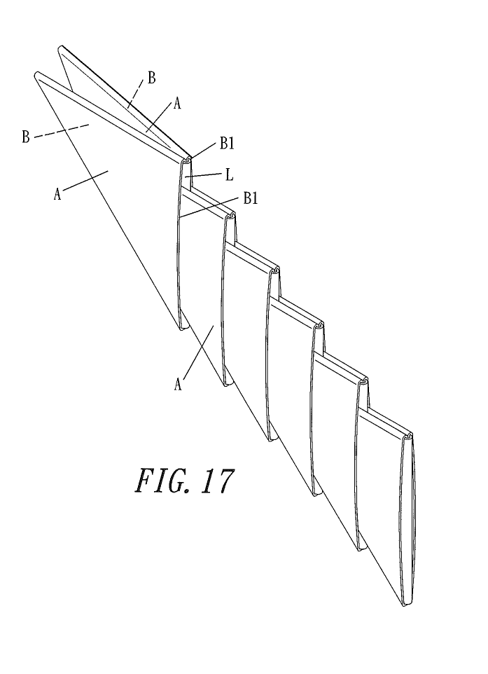

In FIG. 16, the three-dimensional triangular paper block uses a spine line L for the support, and both left and right sides is extended forward along two shoulder lines S to form two small right-angled triangular arms A respectively, and the inner sides of the two arms A embrace the two wings W respectively, and each of both sides of the spine line L has a pocket B1, which is penetrated deeply inside to form a receptacle B. In other words, the receptacles B are disposed inside the two arms A respectively, and the two pockets B1 of the two receptacles B are disposed on both sides of the spine line L respectively, so as to complete the structure of a three-dimensional triangular paper block. During an application as shown in FIG. 17, the two arms A of any (or the second) three-dimensional triangular paper block are inserted from the two pockets B1 of the other (or the first) three-dimensional triangular paper block into the receptacles B respectively, so that the two adjacent front and rear three-dimensional triangular paper blocks can be connected and combined closely with each other by inserting the arms A into the receptacles B, and such connection is a basic insertion and connection of the three-dimensional triangular paper block. Of course, other advanced method or innovation for inserting and connecting the paper blocks may be adopted to produce various different lifelike models.

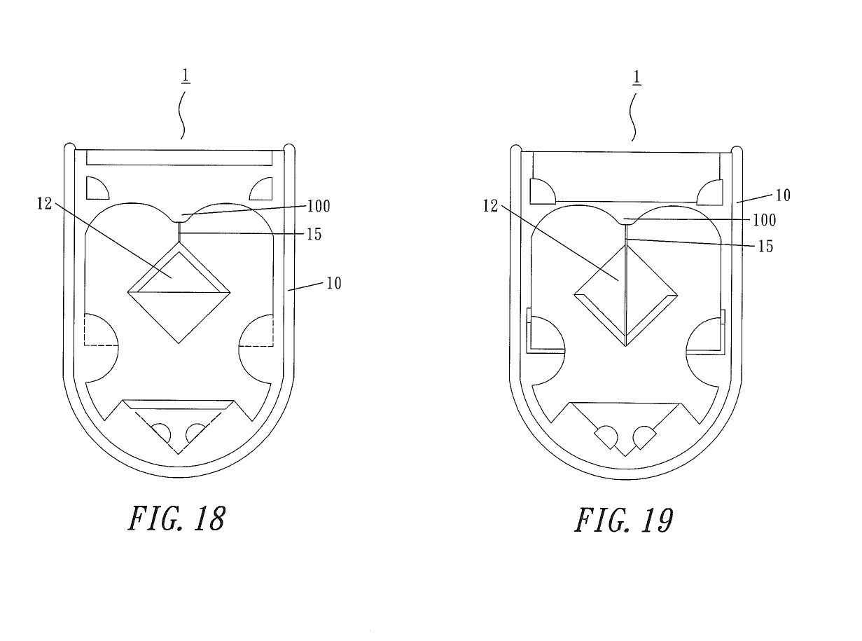

In the first embodiment, the primary forming board 12 is coupled directly by the stand 100 which is extended from the outer frame 10 to define the status of suspending in the internal space of the outer frame 10 (as shown in FIGS. 1˜4), and the primary forming board 12 and the stand 100 may be connected according to another way as shown in FIGS. 18 and 19, wherein a slender connecting rod 15 is provided for connecting the stand 100 with the primary forming board 12 directly, or a slender connecting rod 15 is provided for connecting the primary forming board 12 with a horizontal frame of the outer frame 10 (wherein the connecting position of the connecting rod 15 and the primary forming board 12 is just like a base block), so that the primary forming board 12 is also situated in the status of suspending in the internal space of the outer frame 10, so that the folding operation of the folding paper P also has the convenience of guiding the folding paper to be folded according to the folding sequence and the specification precisely. This structure is especially applicable for a folding paper P with an aspect ratio substantially equal to 2:1. The procedure of guiding the folding paper with such aspect ratio is the same as the aforementioned procedure and thus will not be repeated.

In the aforementioned folding paper procedure, the folding operation by using the first forming board 11 and the second forming board 14 is simply the operation of executing the paper folding steps and does not require any other tools to complete the operation, so that the first forming board 11 and/or the second forming board 14 may be omitted selectively in the manufacture of the paper folding aid. However, the operation folding paper by the primary forming board 12 requires the steps of folding the paper in different directions for several times, so that the size and specification of the folded product may be inconsistent without using an aid, and even worse, the folded product may be deformed, and thus resulting in a poor connection between the three-dimensional triangular paper blocks and failing to meet the basic requirements of the paper blocks. In some cases, it is necessary to use glue to connect the paper blocks, and thus discouraging beginners easily. Therefore, the primary forming board 12 is the most important structure of the present invention and also the major technical feature of the present invention.

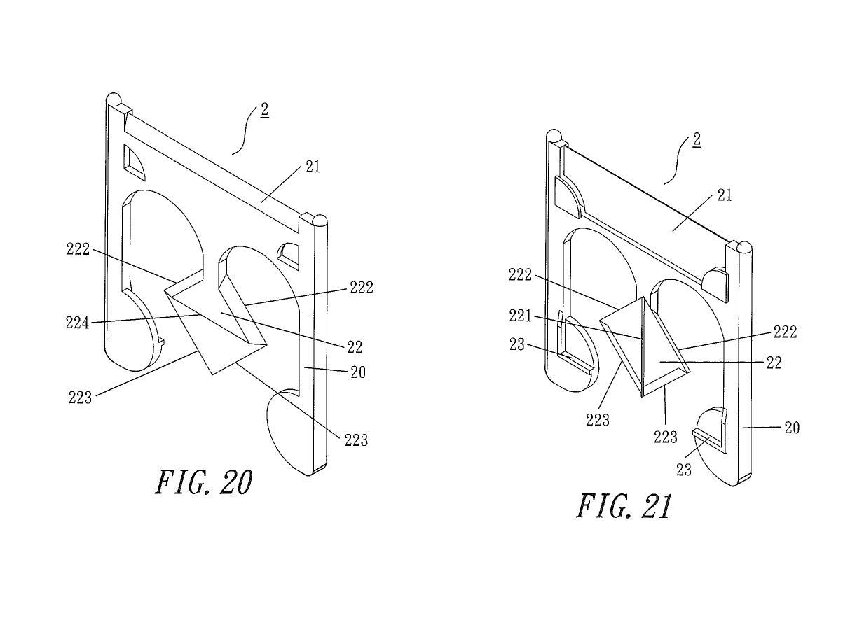

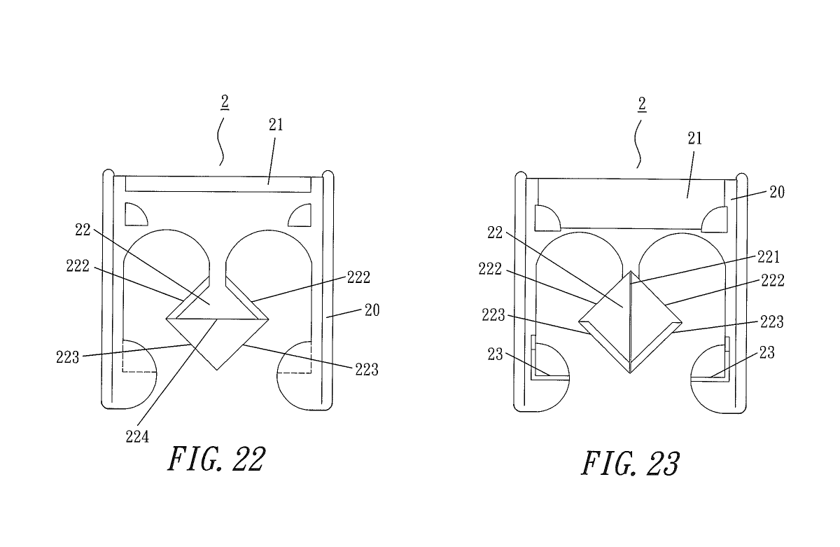

When the present invention selectively omits the second forming board 14 and adopts the design of a paper folding aid 2 of a second embodiment. With reference to FIGS. 20˜23, the structure of the paper folding aid 2 also comprises an outer frame 20, a first forming board 21, a primary forming board 22 and two placement stairs 23, wherein the primary forming board 22 also has a vertical midline 221, two upper bevel edges 222, and two lower bevel edges 223 connected into a right angle (90°), and a horizontal midline 224, and the structure of this embodiment is the same as that of the first embodiment except that the second forming board 14 of the first embodiment is omitted in the paper folding aid 2 of this embodiment.

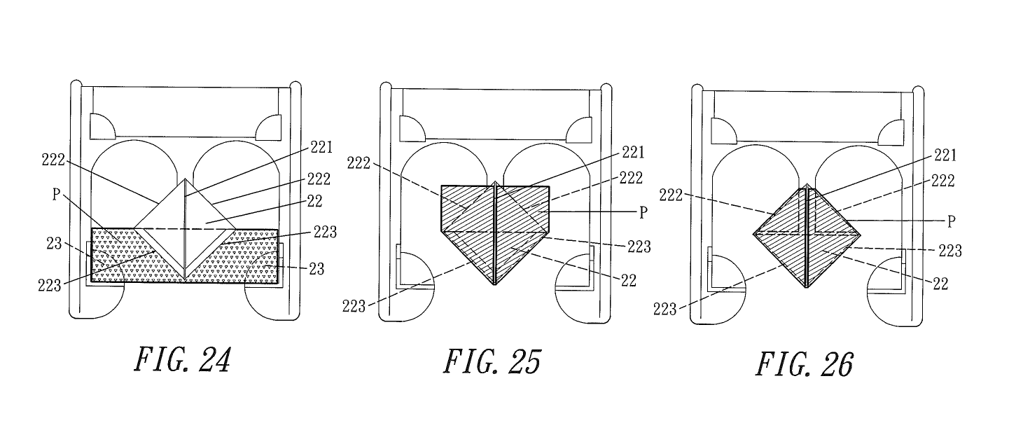

Since the structure of the outer frame 20, the first forming board 21, the primary forming board 22 and the placement stair 23 of the paper folding aid 2 and the operation and sequence of folding paper in accordance with the second embodiment are the same as those of the first embodiment, and thus will not be repeated. With reference to FIGS. 24˜26 for the rear views showing the sequence of folding the folding paper P by the first forming board 21 and guiding the folding paper by the primary forming board 22, the sequence of folding the folding paper as shown in FIGS. 24˜26 is the same as that of the first embodiment as shown in front views (FIGS. 8˜10). In FIG. 26, after the primary forming board 22 is used for folding paper, the procedure of folding the previous folding paper is released, the folding paper P is removed from the primary forming board 22. Now, FIGS. 11(a) and (b) show the front and rear views of the independent folding paper P respectively. Users may operate the operation of dividing the folding paper P into an upper half with left and right wings and folded towards the right-angled triangular lower half to attach to the top side of the lower half, so as to produce an isosceles right-angled triangle, wherein one of the sides is attached to the two divided wings and the other side is divided into two small right-angled triangles. And then, the two bevel edges of the isosceles right-angled triangle is folded along its centerline and attached to a surface having the two divided wings, so as to complete the production of a three-dimensional triangular paper block as shown in FIG. 16.

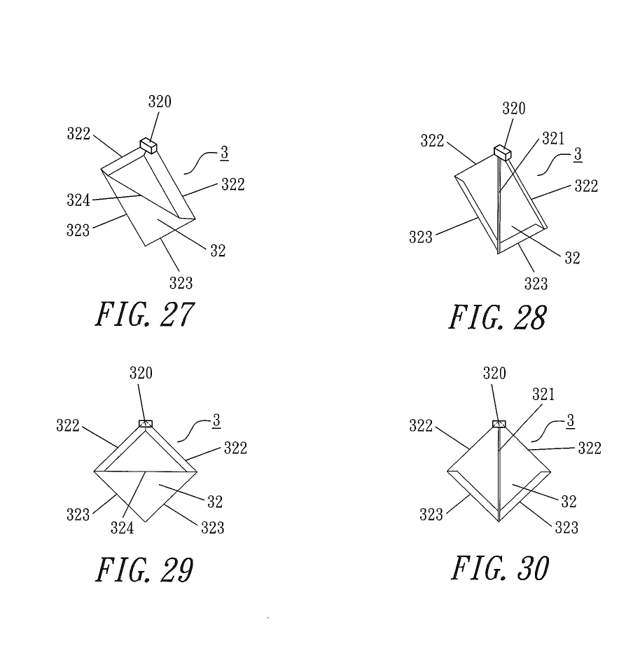

The paper folding aid 2 of the second embodiment is a paper folding aid with an outer frame. For a more skillful operator who folds the folding paper into the three-dimensional triangular paper block, the operation of guiding the folding paper by the primary forming board will be more flexible, freer and convenient without the existence of the outer frame, and the process of folding paper is not necessary the same as described above. With reference to FIGS. 27˜30 for a paper folding aid 3 in accordance with the third embodiment of the present invention, the spirit of the present invention resides on using a primary forming board 32 for the operation of folding paper according to a specification, but this embodiment just uses the primary forming board 32 to execute the operation of folding three-dimensional triangular paper block only after the folding paper P has been folded along the lengthwise direction by using the centerline for reference.

The specification of the primary forming board 32 of the third embodiment matches the specification of the folding paper P, and the top end is a base block 320 capable of providing a positioning guide to the folding paper P, and the base block 320 is equivalent to the connecting position of the stand 100 and the primary forming board 12, and also equivalent to the connecting position of the connecting rod 15 and the primary forming board 12. An edge of the primary forming board 32 is extended obliquely from the base block 320 to both sides to form two isosceles upper bevel edges 322, and then extended inwardly and obliquely to form two isosceles lower bevel edges 323, and the two isosceles lower bevel edges 323 are connected into a right angle (90°). One of the sides of the primary forming board 32 has a vertical midline 321 at its vertical centerline position and a length substantially equal to half of the length of the matched folding paper P to provide a vertical positioning guide to the folding paper P; and the turning points between the two upper bevel edges 322 and the two lower bevel edges 323 on the other side of the primary forming board 32 are connected to form a horizontal midline 324 with a width substantially equal to the width of the matched folding paper P, and the height difference of its upper half and lower half structures provides to a horizontal positioning guide to the folding paper P.

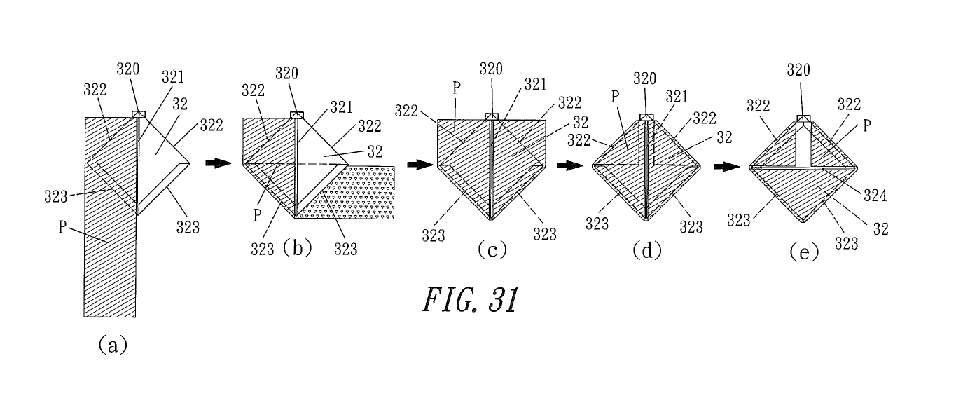

With reference to FIG. 31 for the paper folding aid 3 used in this embodiment, a folded folding paper P is vertically attached to the back side of the primary forming board 32, so that the folding line of the folding paper P is aligned precisely with a side of the vertical midline 321 and its top edge touches the base block 320 as shown in FIG. 31(a), and then the lower section of the folding paper P is folded 45° forwardly and obliquely along one of the lower bevel edges 323, so that the lower section of the folding paper P is folded to the other side of the front as shown in FIG. 31(b), and then the lower section of the folding paper P is folded 45° backwardly and obliquely from the other side of the front and along the other lower bevel edge 323, so that the folding line of the folding paper P is aligned precisely with the other side of the vertical midline 321, and the top edge almost touches the base block 320 and is aligned precisely with the other top edge as shown in FIG. 31 (c), and then a portion of the top edges of the two folding papers P is folded downwardly and obliquely from the front to the back along the two upper bevel edges 322, so that the folding paper P is completely covered onto the primary forming board 32 as shown in FIG. 31(d). Now, the other side of the covered folding paper P is situated at a status as shown in FIG. 31(e). Now, the whole operation of folding paper by using the primary forming board 32 is completed, and then the previous operation of folding paper is released, and the covered folding paper P is removed from the primary forming board 32. Now, the independent folding paper P is situated in a status as shown in the front and rear views (FIGS. 11(a) and (b)). Users may divide the folding paper P into an upper half with left and right two wings and fold a right-angled lower half to attach on a side of the lower half to form an isosceles right-angled triangle, and one of the sides is attached to the divided wings and the other side is divided into two small right-angled triangles. Finally, the two bevel edges of the isosceles right-angled triangle attached to a surface having the two divided wings are folded and engaged according to its centerline, so as to complete folding the three-dimensional triangular paper block as shown in FIG. 16.

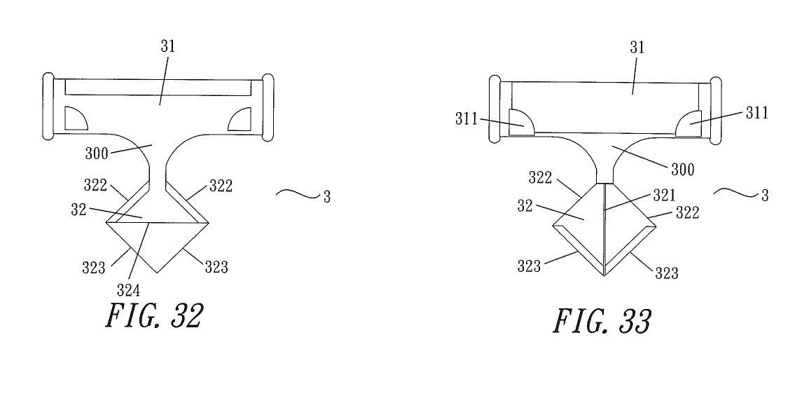

To facilitate uses to prepare the folding paper P for the paper folding aid 3 in accordance with the third embodiment, the paper folding aid of the present invention may be modified from the third embodiment into those as shown in FIGS. 32 and 33, and such paper folding aid comprises a first forming board 31 having the same structure and function as those of the first and second embodiments, wherein the first forming boards 11, 21 and the primary forming board 32 have the same structure and function as the primary forming board 32 of the third embodiment without having the outer frame, except that the first forming board 31 is extended downwardly to the connecting position of the primary forming board 32 to connect the stand 300, and its structure and function are the same as the stand 100 in the first and second embodiments, and the base block 320 of the original third embodiment is substituted, but such structure also provides the positioning guide function to the base block 320. Therefore, the paper folding aid as shown in FIGS. 32 and 33 adopts the same procedure of folding paper by the first forming board 11, 21 in accordance with the first and second embodiments and the later procedure and sequence of manually separating the folding paper in accordance with the third embodiment to complete the manufacture of the three-dimensional triangular paper block as shown in FIG. 16, and the detailed process will not be repeated.

Of course, the paper folding aid of the present invention may be manufactured into an assembly just having the primary forming board and the second forming board (not shown in the figure) only, and the primary forming board and the second forming board are provided for assisting the folding paper operation, so as to fold a three-dimensional triangular paper block quickly and precisely according to a specification, and thus modifications of using the first forming board, the second forming board, and the primary forming board for the paper folding aid still falls within the scope of the present invention.

It is noteworthy that the terms “front”, “back”, “up”, “down”, “top”, “bottom”, “left”, “right” described in the specification and the directions shown in the figures are provided for the purposes of defining the relations of components and facilitating the illustration of the present invention only, but they are not necessary absolutely constant. For example, a part (or assembly) situated on the front side (or at the front position) will become a part (or assembly) situated on the back side (or at the back position) when the whole paper folding aid is switched 180° along the front-back direction. Similarly, a part (or assembly) situated on the top side (or at the top position) will become a part (or assembly) situated on the bottom side (or at the bottom position) when the whole paper folding aid is turned upside down. Regardless of turning the paper folding aid 180° along the front-back direction or upside down, the three-dimensional triangular paper block can be folded, and thus the scope of the invention is not limited to the direction of turning the paper folding aid.

The present invention primarily provides a paper folding aid for carrying out the procedure, method, and sequence of the origami handcraft for folding three-dimensional triangular paper blocks according to the size and specification of the origami precisely and quickly, so as to assure the proper connection and combination between the paper blocks and makes the origami handcraft of the three-dimensional triangular paper block to be scientific and fun, and an easily learned novel technique. The process of folding and producing the three-dimensional triangular paper blocks is no longer boring or difficult, so that the art of combining the three-dimensional triangular paper block can be promoted with unlimited creativity, and such precious and environmentally friendly handcraft can be promoted and used for producing cultural and creative products and can be spread from generation to generation.

In summation of the description above, the three-dimensional triangular paper block paper folding aid of the present invention is a novel device with the effect of conducting the procedure, method and sequence of folding paper according to the required size and specification precisely and quickly and complies with patent application requirements, and is thus duly filed for patent application. While the invention has been described by means of specific embodiments, numerous modifications and variations could be made thereto by those skilled in the art without departing from the scope and spirit of the invention set forth in the claims.

What is claimed is:

1. A three-dimensional triangular paper block paper folding aid, with a specification matched with the specification of a folding paper, comprising a primary forming board, and the top end of the primary forming board being a base block capable of providing a positioning guide to the folding paper, and an edge of the primary forming board being extended obliquely from the base block towards both sides to form two isosceles upper bevel edges, and then extended inwardly and obliquely to form two isosceles lower bevel edges, and the two isosceles lower bevel edges being coupled into a right angle (90°).

2. The three-dimensional triangular paper block paper folding aid according to claim 1, wherein a side of the primary forming board has a vertical midline at a vertical centerline position, and the length of the vertical midline is substantially equal to half of the length of the matched folding paper to provide a vertical positioning guide to the folding paper.

3. The three-dimensional triangular paper block paper folding aid according to claim 1, wherein the other side of the primary forming board has a horizontal line formed by connecting the turning points between the two upper bevel edges and the two lower bevel edges, and the width of the horizontal midline is substantially equal to the width of the matched folding paper to provide a horizontal positioning guide to the folding paper.

4. The three-dimensional triangular paper block paper folding aid according to claim 1, wherein the top of the primary forming board is coupled to a first forming board which is formed by a rectangular thin plate, and the back side of the primary forming board has a positioning press plate with a width substantially equal to the length of the matched folding paper and a height substantially equal to half of the width of the matched folding paper.

5. The three-dimensional triangular paper block paper folding aid according to claim 1, further comprising an outer frame with a middle position downwardly coupled to the primary forming board by a connecting rod.

6. The three-dimensional triangular paper block paper folding aid according to claim 1, further comprising an outer frame, and a stand being extended inwardly towards both sides of the outer frame, and the primary forming board being suspended downwardly from a middle position of the stand.

7. The three-dimensional triangular paper block paper folding aid according to claim 6, wherein each outer frame disposed on the outer side of the two lower bevel edges of the primary forming board has a positioning device for precisely aligning the connecting points of the bottom edge and the two lower bevel edges.

8. The three-dimensional triangular paper block paper folding aid according to claim 7, wherein the outer frame is coupled to a first forming board which is formed by a rectangular thin plate, and the back side of the first forming board has a positioning press plate with a width substantially equal to the length of the matched folding paper and a height substantially equal to half of the width of the matched folding paper.

9. The three-dimensional triangular paper block paper folding aid according to claim 8, wherein the outer frame is coupled to a second forming board which is formed by an inverted triangular thin plate, and the back side of the second forming board has a positioning press plate with a specification substantially the same as the specification of the lower half of the primary forming board.

10. The three-dimensional triangular paper block paper folding aid according to claim 1, wherein the upper bevel edge and lower bevel edge of the primary forming board and the top edges of the first forming board and the second forming board are preferably in the shape of a sharp wall.

11. The three-dimensional triangular paper block paper folding aid according to claim 1, wherein the three-dimensional triangular paper block paper folding aid is operated freely without being limited by forward, backward, up, down, left, and right directions.
